(19) United States
(12) Patent Application Publication
(10) Pub. No.: US 2013/0192073 A1
(43) Pub. Date: Aug. 1, 2013

(54) LASER TARGETING VIEWING DEVICE AND METHOD

(71) Applicant: TROPHY TRUST, LLC, Gainesville, FL (US)

(72) Inventor: Garrett William Gleim, Gainesville, FL (US)

(73) Assignee: TROPHY TRUST, LLC, Gainesville, FL (US)

(21) Appl. No.: 13/752,073

(22) Filed: Jan. 28, 2013

Related U.S. Application Data
(60) Provisional application No. 61/592,275, filed on Jan. 30, 2012.

(51) Int. Cl. G01C 3/00

(52) U.S. Cl. CPC G01C 3/00
USPC 33/228; 33/293

(57) ABSTRACT

A targeting viewing device is disclosed that couples a laser pointer to a viewing device such as binoculars or a spotting scope. In one embodiment the laser pointer includes a switch to selectively activate a laser beam to project a spot of light on a distant target so as to identify the target from within a group of potential targets to other observers of the targets. The viewing device may include a spotting scope, monocular, binocular or camera.

### CROSS REFERENCE TO RELATED APPLICATIONS

This application claims the benefit of priority of U.S. Provisional Patent Application Ser. No. 61/592,275, filed Jan. 30, 2012, entitled TARGETING BINOCULARS, the content of which is hereby incorporated by reference in its entirety.

### BACKGROUND OF THE DISCLOSURE

During a big game hunt often a number of potential target animals are found grouped together in a herd. A hunting guide typically will point out to his or her client a particularly desirable animal to shoot with his or her fingers. The guide pointing to the animal is not the ideal way to determine which animal is to be shot. It is very imprecise. Often the intended target animal is not hit and instead a different animal is targeted by the hunter client. Therefore there is a need for a more precise and convenient way to quickly identify to a hunter a specific target animal.

### SUMMARY OF THE DISCLOSURE

The present disclosure directly addresses this problem. A target identifying device in accordance with the present disclosure includes an optical viewing element; and a laser pointer fastened to the viewing element. The viewing element permits a user to view a target through the element. The pointer projects a laser spot on a target being viewed through the viewing element, such that another person adjacent the person using the viewing element can see the laser spot.

One particular device in accordance with the present disclosure is a targeting binocular which includes a modified laser pointer fastened to a pair of binoculars. The laser pointer is adjusted so that the laser spot projected by the pointer is positioned at the center of the field of view of the binoculars and its power is sufficient to illuminate a spot on a target that can in turn be clearly seen through the binoculars. When the guide selects the target animal, centers the binoculars on that animal and activates the pointer, an illuminated spot is projected onto the animal. This illuminated spot is bright enough to be seen through the hunter's riflescope. The hunter then aims at that animal for the shot. Furthermore, the illuminated spot is typically sufficiently defined such that it can be used by the guide to indicate the point of aim on the animal to indicate a clean kill shot to the hunter.

Further features, advantages and characteristics of the embodiments of this disclosure will be apparent from reading the following detailed description when taken in conjunction with the drawing figures.

### DESCRIPTION OF THE DRAWINGS

FIG. 1 is a perspective view of a targeting binocular viewing device in accordance with the present disclosure.

FIG. 2 is a schematic representation of a shooting situation in which the targeting binocular viewing device can be used.

FIG. 3 is a perspective view of another embodiment of a targeting binocular viewing device in accordance with the present disclosure.

FIG. 4 is a side view of the targeting binoculars shown in FIG. 3.

FIG. 5 is a perspective view of another embodiment of the viewing device in accordance with the present disclosure.

FIG. 6 is a flow diagram of the process necessary to use the viewing device in accordance with the present disclosure.

### DETAILED DESCRIPTION

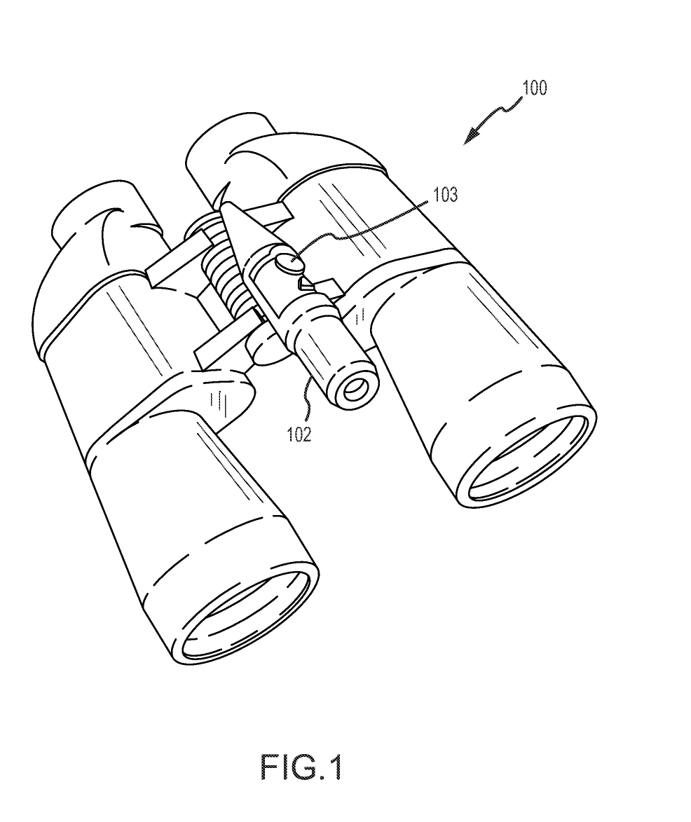

An exemplary embodiment of a targeting binocular viewing device 100 is shown in FIG. 1. Mounted to one of the lens casings or to the binocular frame is a battery powered laser pointer 102. This pointer 102 is a high power laser device of sufficient power to produce a bright illuminated circle of light, typically red, on a target at 100-200 yards that is separately visible to an observer located close to but spaced from the user of the binoculars. The pointer 102 has an activation switch 103 preferably on its side that can be easily turned on and off by the guide 106 using the binoculars.

The pointer 102 in accordance with the present disclosure is very high power, on the order of 10-100× brighter that a conventional office whiteboard laser pointer. For example, a 100 mW laser is believed to be sufficiently powerful for this use. One such laser pointer is an E3 Elite Series red laser pointer marketed by Wicked Lasers.

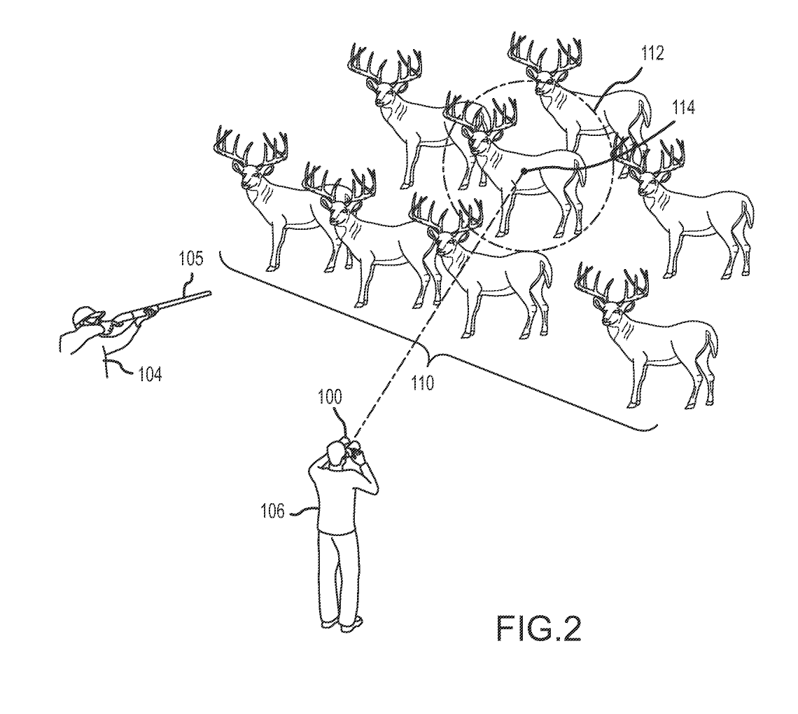

A schematic scene of the use of the binocular viewing device 100 is shown in FIG. 2. A hunter 104 and a guide 106 are shown viewing a herd of animals 110 at a distance, such as 50-200 yards. The guide 106 uses the binoculars 100 to assess the herd and pick out a suitable target animal for the hunter 104 to shoot. When the guide identifies an appropriate target animal 112, he or she switches on the pointer 102 via the switch 103. The pointer 102, aligned with the field of view of the binoculars 100, projects a target spot 114 onto the animal 112. The guide fine tunes the location of the spot 114 on the animal 112. The hunter 104, using his or her riflescope 105 can then aim directly at the illuminated target spot 114 for the shot.

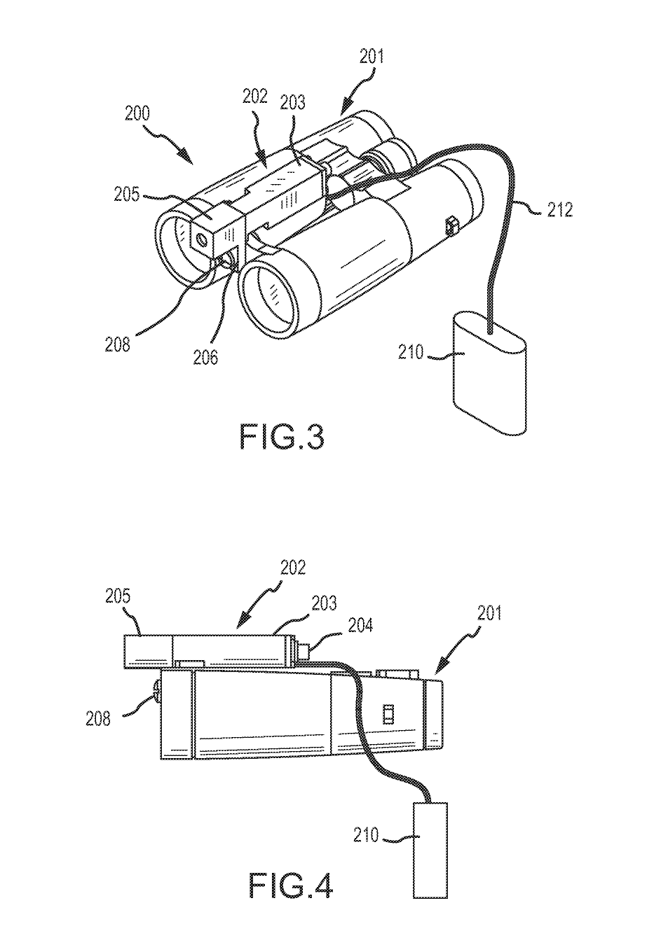

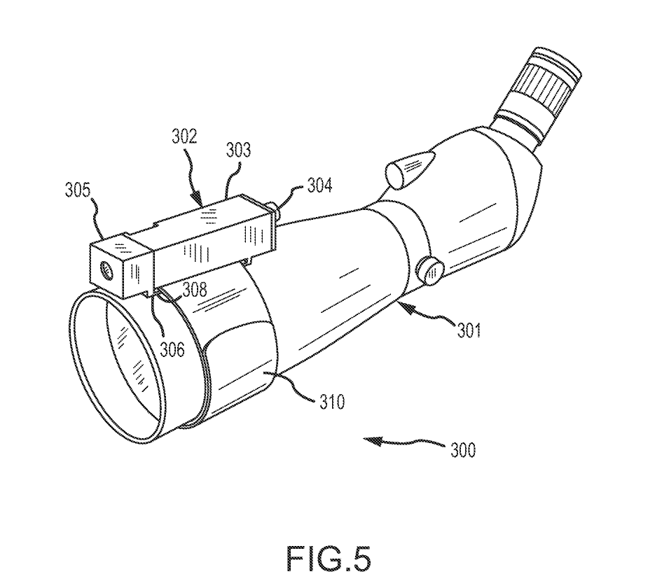

A second embodiment of a viewing device in accordance with the present disclosure is a pair of targeting binoculars 200 as is shown in a perspective view in FIG. 3 and in a side view in FIG. 4. A laser pointer/targeting assembly 202 is fastened to one of the hinges of a conventional pair of binoculars 201. The exemplary pair of binoculars illustrated is a pair of roof prism system binoculars.

The Laser targeting assembly 202 on this exemplary set of binoculars 201 has an elongated, rectangular cylinder body 203 that houses the electronics for the laser, and has an on/off switch 204 extending axially rearward at its rear end. A battery power supply 210 is connected to the electronics via a wire cord 212. This battery supply 210 may be fastened to one of the binocular barrels by any suitable means, or, if the cord 212 is long enough, the supply 210 can be carried in one of the viewing device user's pockets. Alternatively, the battery power supply may be miniaturized and housed within the body 203 itself, thus eliminating the need for a box type battery supply 210 and cord 212.

The front end of the body 203 is fastened to a front laser portion 205 that carries the optical elements of the laser. The front portion 205 has a flange 206 for fastening the assembly 202 to the hinge screw 208 of the binoculars 201. The laser assembly 202 is adjusted on the hinge screw 208 such that the laser points coincident with the center of the view field of the binoculars 201 so that the user can easily point the laser spot 114 on the target animal as shown in FIG. 2 and described above with reference to the first embodiment.

Many variations of the target viewing device exemplified by the targeting binoculars 100 and 200 can be made. The pointer 102 may be integrated into the binocular housing itself. The pointer 102 may alternatively be attached to or integrated into a monocular or conventional spotting scope, or any other viewing device, and may alternatively attached to a camera. The laser assembly 202, for example, may be furnished with a Velcro type hook and loop type fastener strip attached to the body 202 so that the laser assembly 202 may be removably fastened either tubular part of the binoculars 201.

An alternative viewing device 300 with a laser targeting assembly 302 mounted on the barrel of a spotting scope 301 is shown in FIG. 5. In this embodiment, a removable configuration, the flange 206 that is shown in FIGS. 3 and 4 is modified. The laser targeting assembly 302 again has an elongated body 303 attached to or integral with a laser portion 305. The body 303 carries a switch 304 for energizing the laser targeting light beam that is projected by the assembly 302. The laser portion 305 of the body 302 includes a flange 306 that has an axially extending leg that extends parallel to the body 302. The flange leg 308 is spaced from the body 302 just enough to receive a strap 310 of hook and loop fastener material that is snugly wrapped around the barrel of the spotting scope 301 rather than receiving a mounting screw 208 as shown in FIGS. 3 and 4 to fasten the assembly 202 in place. In this embodiment 300, the battery power supply is preferably miniaturized and housed within the body 303 as is shown, or it may alternatively be a separate battery pack supply as is shown in FIGS. 3 and 4.

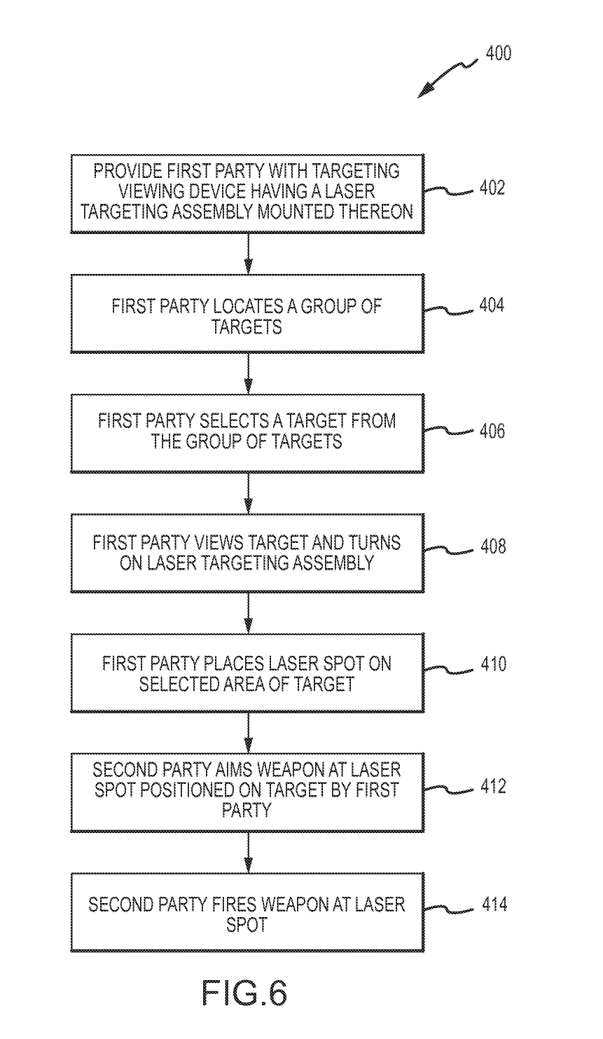

FIG. 6 illustrates the sequence 400 of operations necessary to be performed by a user such as guide 106 and hunter 104, in utilizing any one of the viewing devices 100, 200 and 300 in accordance with the present disclosure.

These operations begin in operation 402 where a first party such as the guide 106 is provided with a viewing device 100, 200, or 300 before tracking a group of target animals such as deer, antelope, lion or elephant with a second party such as hunter 104.

Next the first and second parties locate a group of targets in a conventional manner in operation 404. The first party then views the targets and selects a particular target such as a particular animal target 112 in operation 406. The first party then energizes the laser targeting assembly 102, 202 or 302, looks at the target through the viewing device 100, 200 or 300 in operation 408 and positions the targeting spot 114 of laser light on the target animal 112 at the desired place 114 in operation 410. The second party, e.g., the hunter 104, then sights his or her weapon at the targeting spot 114 on the target 112 in operation 412 and in operation 414 takes the shot.

Many variations will be apparent to those skilled in the art. The hunter 104 may be a bow hunter, or other category of hunter utilizing any conceivable weapon, not just a rifle as illustrated in FIG. 2. The present disclosure also applies to non-hunting activity as well, such as photographers and bird watchers to name a few. The targeting viewing device may be used in any circumstance where a first party wants to indicate, or single out, a particular target area from within any type of broader grouping to a second party. Furthermore, the color of the laser light, e.g. red, green, blue, yellow, may be selected so as to minimize detection by the target animals. A green laser is particularly suitable for large game in Africa, for example. Optionally optical filters may be attached to the binocular or spotting scope objective lenses to enhance visible contrast of the laser spot on a target. Such filters may also be used on a hunter's telescopic sight or glasses for this purpose. This may improve the ability of each party to distinguish the laser spot on a target in bright sunlight conditions. All such changes, alternatives and equivalents in accordance with the features and benefits described herein, are within the scope of the present disclosure. Such changes and alternatives may be introduced without departing from the spirit and broad scope of this disclosure as defined by the claims below and their equivalents.

What is claimed is:

1. A target identifying viewing device comprising:
an optical viewing element; and
a laser pointer assembly fastened to and co-aligned with the viewing element, wherein the viewing element permits a user to view a target through the element and wherein the pointer projects a laser light spot on a target being viewed through the viewing element.

2. The device according to claim 1 wherein the viewing element is a pair of binoculars.

3. The device according to claim 2 wherein the binoculars includes an optics housing and the pointer assembly is mounted above the housing.

4. The device according to according to claim 1 wherein the pointer assembly has a switch configured to energize the laser light to project the laser spot when the switch is activated.

5. A method of identifying a target from amongst a group of potential targets, the method comprising:
attaching a laser pointer to a viewing device and providing the viewing device to a first party;
the first party aiming the viewing device at one of the potential targets;
activating the pointer to project an illuminated spot on the one of the potential targets such that a second party can see the illuminated spot;
the first party positioning the illuminated spot on the target at a predetermined area; and
permitting the second party to view the illuminated spot through another viewing device to identify the target.

6. A laser targeting viewing device comprising:
an optical viewing device having a viewing axis; and
a laser targeting assembly fastened to the optical viewing device, wherein the laser targeting assembly has a laser light generating portion and a generally cylindrical body fastened to the optical viewing device, wherein the laser light generating portion is aimed along the viewing axis of the optical viewing device.

7. The device according to claim 6 wherein the optical viewing device is a pair of binoculars and the targeting assembly is threadably fastened to a hinge joint of the pair of binoculars.

8. The device according to claim 6 wherein the laser light generating portion has a flange for fastening the assembly to the optical viewing device.

9. The device according to claim 8 wherein the flange includes an axially extending leg alongside the body.

10. The device according to claim 6 further comprising a battery power supply connected to the cylindrical body and wherein the power supply is removably attachable to optical viewing device.

11. The device according to claim 10 wherein the power supply is connected to the laser targeting assembly via a wire cord.

12. The device according to claim 8 wherein the laser targeting assembly is fastened to the optical viewing device with a strap of hook and loop material positioned over the leg of the flange and wrapped around a barrel of the optical viewing device.

13. A target identifying viewing device comprising:
an optical viewing device having a viewing axis;
a laser targeting assembly fastened to the viewing device, the assembly comprising:
an elongated rectangular body housing laser light generation circuitry;
a laser light generating portion fastened to the body and positioned to direct laser light along the viewing axis toward a target;
a battery power supply connected to the circuitry in the elongated rectangular body; and
the body having a switch protruding from the body for energizing the circuitry to produce the laser light.

14. The device according to claim 14 wherein the optical viewing device is a spotting scope.

15. The device according to claim 14 wherein the optical viewing device is a pair of binoculars.

16. The device according to claim 15 wherein the laser light generating portion includes a radial flange for fastening the assembly to a central hinge between the binoculars.

17. The device according to claim 16 wherein the battery power supply is removably fastened to one lens barrel of the pair of binoculars.
